(19) United States
(12) Patent Application Publication
(10) Pub. No.: US 2007/0005451 A1
(43) Pub. Date: Jan. 4, 2007

(54) CROP VALUE CHAIN OPTIMIZATION

(75) Inventors: ROBERT C. IWIG, Johnston, IA (US); SUE M. HOOVER, Webster City, IA (US); TODD A. PETERSON, Johnston, IA (US); RUSSELL F. SANDERS, Waukee, IA (US)

Correspondence Address: MCKEE, VOORHEES & SEASE, P.L.C.;ATTN: PIONEER HI-BRED, 801 GRAND AVENUE, SUITE 3200, DES MOINES, IA, 50309-2721, US

(73) Assignees: PIONEER HI-BRED INTERNATIONAL, INC., Johnston, IA (US); E. I. du PONT de NEMOURS and COMPANY, Wilmington, DE (US)

(21) Appl. No.: 11/423,523

(22) Filed: Jun. 12, 2006

Related U.S. Application Data
(60) Provisional application No. 60/760,130, filed on Jan. 19, 2006.
(60) Provisional application No. 60/689,716, filed on Jun. 10, 2005.

(51) Int. Cl. G06Q 30/00

(52) U.S. Cl. 705/27

(57) ABSTRACT

A method for optimizing a supply chain for grain includes providing an information system adapted to exchange information with at least one input supplier providing seed to the producer, at least one producer providing grain grown from the seed, and at least one processor providing a product produced using the grain. The information system is adapted to provide an output indicative of grain quality and quantity to the at least one processor prior to harvest of the grain to thereby assist the at least one processor in optimizing the supply chain.

### CROSS-REFERENCE TO RELATED APPLICATIONS

This application claims priority to U.S. Provisional Patent Application Ser. No. 60/760,130 filed Jan. 19, 2006, hereby incorporated by reference in its entirety. This application further claims priority to U.S. Provisional Patent Application Ser. No. 60/689,716 filed Jun. 10, 2005, also incorporated by reference in its entirety.

### BACKGROUND OF THE INVENTION

The present invention relates to crop value chain optimization. More specifically, but without limitation, the present invention relates to, without limitation, creation, capture, preservation, and leveraging information across a crop production, transport, and delivery system.

The supply chain or crop value chain for agricultural crops creates specific problems which are not found in other types of supply chains. Agricultural enterprises have attendant uncertainty in production which creates risks for those downstream in the supply chain. Quality as well as quantity of a crop and delivery of a crop is difficult to predict which complicates supply chain management. The quality of a crop relative to a particular use down the chain affects the value of the crop down the chain, therefore sometimes a supply chain is referred to herein as a value chain. What is needed is a method and system for optimizing the supply chain for an agricultural crop.

### BRIEF SUMMARY OF THE INVENTION

Therefore, it is a primary object, feature, or advantage of the present invention to improve over the state of the art.

Another object, feature, or advantage of the present invention is to provide for value creation and capture from a value chain.

It is a further object, feature, or advantage of the present invention to provide for optimization of a supply chain.

Yet another object, feature, or advantage of the present invention is to provide for information driven coordination of a supply chain.

A still further object, feature, or advantage of the present invention is to take advantage of a compressed value chain.

Another object, feature, or advantage of the present invention is to provide a mechanism with which to understand supply chain and value chain problems and economics in order to create efficiencies such as risk reduction and productivity optimization.

Yet another object, feature, or advantage of the present invention is to align decision-making within a networked system of farms, input suppliers, grain purchasers, delivery points, processors or livestock producers.

A further object, feature, or advantage of the present invention is to provide for integrated information management throughout a supply chain.

A still further object, feature, or advantage of the present invention is to aggregate and leverage data in order to create new value.

Another object, feature, or advantage of the present invention is to provide for the flow of information upstream and downstream with a supply chain in order to optimize decision-making across the chain.

Yet another object, feature, or advantage of the present invention is to provide a system that can be used to understand variability within the crop.

A still further object feature, or advantage of the present invention is to provide a system that can be used to manage or control variability once variability has been identified.

Another object, feature, or advantage of the present invention is to provide for reduced risk through controlled variation or predicted variation.

Yet another object, feature, or advantage of the present invention is to provide for consistent and predictable grain volumes or grain flows.

A still further object, feature, or advantage of the present invention is to provide for consistent and predictable grain quality.

A further object, feature, or advantage of the present invention is to provide for more efficient and optimized production through optimized inputs and/or proper asset utilization.

A still further object, feature, or advantage of the present invention is to provide for spatial management practices to assist in optimizing inputs.

A still further object, feature, or advantage of the present invention is to provide for a method of receiving information from throughout a supply chain which can be used to improve genetics of a seed input.

Another further object, feature, or advantage of the present invention is to provide for a method of receiving information from throughout a supply chain which can be used to improve understanding and application of the interaction between genetics and management practices.

Yet another object, feature, or advantage of the present invention is to provide for information flow to assist a processor (including, but not limited to a livestock producer or an ethanol producer) in timely receiving grain of a desired quality in order to meet their processing demands in the most efficient manner.

A further object, feature, or advantage of the present invention is to provide for predicting grain quality, harvest time, delivery time, and/or related information while grain is still in the field.

A still further object, feature, or advantage of the present invention is to use knowledge of the interaction between any or all of (1) genetics, (2) genetic-by-environment interactions, (3) genetic-by-environment-by management interactions, and processing steps to assist in determining and managing the quality of grain acquired for processing.

One or more of these and/or other objects, features, or advantages of the present invention will become apparent from the specification and claims that follow.

According to one aspect of the present invention, a method for optimizing a supply chain for grain is provided. The method includes providing an information system adapted to exchange information with at least one input supplier providing seed to the producer, at least one producer providing grain grown from the seed, and at least one processor providing a product produced using the grain. The information system is adapted to provide an output indicative of grain quality to the at least one processor prior to harvest of the grain to thereby assist the at least one processor in optimizing the supply chain. The processor may be an ethanol processor or a livestock producer or other type of processor. Where the processor is an ethanol processor, preferably the grain is corn. Where the processor is an ethanol processor, ethanol yield potential is one example of an output indicative of grain quality. Where the processor is a livestock producer, predicted digestible energy levels is one example of an output indicative of grain quality. Other types of outputs indicative of grain quality include, without limitation, protein content, oil content, starch content, and extractable starch content. Grain quality can be determined in various ways, including through chemical sample analysis, using techniques such as near infrared analysis or other tools or through predictions based on genetics, environment, and management practices.

According to another aspect of the invention a system is provided for optimizing a supply chain for grain. The system includes an input from at least one input supplier supplying seed, an input from at least one producer of the grain, and an input from at least one processor. The information system is adapted to provide an output indicative of grain quality to the at least one processor prior to harvest of the grain to thereby assist the at least one processor in optimizing the supply chain. The at least one input supplier preferably includes a seed supplier. The output indicative of grain quality may be at least partially based crop scouting reports, and/or interaction between the genetics of the grain and processing techniques.

According to another aspect of the present invention, a method for acquiring grain is provided. The method includes determining expected grain quality from a plurality of sources at a time prior to harvest of the grain, the expected grain quality based on genetics of the grain, the environment associated with the grain, and genetics-by-environment interactions. The method also provides for determining an expected time of harvest for the grain and identifying sources of grain to acquire to meet processing needs based on expected grain quality, expected time of harvest, and processing needs. The step of identifying sources of grain to acquire to meet processing needs may be further based on interactions between processing steps and grain of varying genetics, such as the use of particular enzymes.

According to another aspect of the present invention, a method for optimizing a supply chain for grain includes determining expected grain quality from a plurality of sources at a time prior to harvest of the grain, the expected grain quality based on genetics of the grain, the environment associated with the grain, genetics-by-environment interactions, and effect of the genetics of the grain on processing steps. The method further includes determining an expected time of harvest for the grain and identifying sources of grain to acquire to meet processing needs based on expected grain quality, expected time of harvest, and processing needs.

### BRIEF DESCRIPTION OF THE DRAWINGS

FIG. 1 is a block diagram of one example of supply chains for a crop such as corn.

FIG. 2 is a block diagram illustrating one embodiment of an information system of the present invention.

FIG. 3 is a flow diagram illustrating one embodiment of a corn-dry milling process.

FIG. 4 is a block diagram illustrating another embodiment of an information system of the present invention.

FIG. 5 is a screen display illustrating one embodiment of a producer profile.

FIG. 6 is a screen display illustrating one embodiment of the collection and/or display of site specific information.

FIG. 7 is screen display illustrating one embodiment of the collection and/or display of a genetic profile.

FIG. 8 is a screen display illustrating one embodiment of the collection and/or display of a producer profile.

FIG. 9 is a screen display illustrating one embodiment, illustrating choices available to a processor for sourcing grain.

### DETAILED DESCRIPTION OF THE PREFERRED EMBODIMENT

The present invention provides for methods and systems for managing information between different participants in an agricultural crop value chain, and in particular in a corn value chain. Managing the information between the different participants provides for value creation and capture from the value chain and provides a basis for optimization of the supply chain. With proper information flow between participants in the value chain decision-making of all participants can be aligned and integrated. With proper information flow, variability within the supply chain can be predicted, managed and/or controlled to thereby reduce risk such as by providing consistent and predictable grain volumes, grain flow, or grain quality. With proper information flow, more efficient and optimized production is achieved through optimized inputs and/or proper asset utilization. For example, genetics of seed input can be optimized for a particular end use.

The present invention recognizes that improved decisions can be made by processors of crops if they have access to sufficient information to make supply chain decisions in sufficient time to make and execute the decisions. These improved decisions provide the potential for increased revenues or profit, less down time, more efficient production processes, as well as other resource management benefits. The present invention further recognizes that this ability to potentially increase revenue for the processors. The processor may be willing and able to share in this additional value created with the provider of the information, the crop producers, or others.

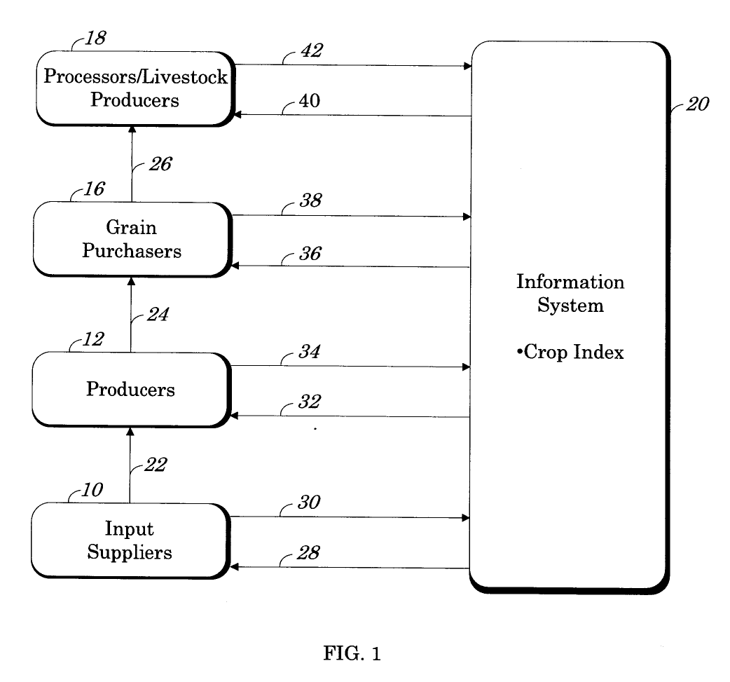

FIG. 1 illustrates one embodiment of an integrated information system for supply chain optimization of corn. The various participants are shown. It is to be understood that each of these participants preferably interacts with the information system electronically, such as through a computer or other electronic device. The participants in the supply chain includes the input suppliers 10. The input suppliers 10 include seed companies, suppliers of fertilizer, pesticides, equipment or other inputs. In addition, the input suppliers 10 can include those who supply financial support in one manner or another such as through bank loans, financing, or otherwise. The input suppliers 10 provide these inputs 22 to farmers or producers 12. The producers 12 grow a crop for harvest in order to provide grain. The grain 24 is sold to a grain purchaser 16 who may store the grain but ultimately distributes the grain 26 to a processor/livestock producer 18. Alternatively, the producers 12 can provide grain directly to the processor/livestock producer 18 without involving the grain purchaser 16 in the process. The processor/livestock producer 18 then feeds the grain to livestock or if a grain producer or produces a different product from the grain, such as ethanol.

The present invention recognizes that not all grain is of equal value to the processor/livestock producer 18. The processor/livestock producer 18 values grain differently according to different characteristics of the grain. Where grain is being used in ethanol production, one characteristic of grain of particular importance is ethanol yield. The processor 18 desires grain having the highest ethanol yield as this type of grain is of most value to their process. Where the grain is being used for feed, the livestock producer 18 desires the grain having the highest feed value, such as based on the predicted digestible energy levels of the grain. Other types of characteristics which may be of value in these or other uses of the grain include, without limitation, protein content, starch content, oil content, extractable starch content, lysine content such as for increased feed value, enzyme content (such as for ethanol processing) etc. The present invention is not to be limited to the end use of the grain or the properties or characteristics of the grain which act as value differentiators for the grain.

The information system 20 of the present invention provides for managing and integrating information flow between participants in the supply chain. The information used in the system includes: (1) information 28 from information system 20 to input suppliers 10; (2) information 30 from input suppliers 10 to information system 20; (3) information 32 from information system 20 to producers 12; (4) information 34 from producers 12 to information system 20; (5) information 36 from information system 20 to grain purchasers 16; (6) information 38 from grain purchasers 16 to information system 20; (7) information 40 from information system 20 to processors/livestock producers 18; and (8) information 42 from processors/livestock producers 18 to information system 20. Of course, information may be obtained from other sources to augment or enhance the information system 20.

One type of information input from the producers 12 to the information system 20 is production information. The production information can include environmental or weather information, placement information, cultural practices information, and fertility management information. This can include basic information such as seed type and field location or can provide for more specific information such as, without limitation, data relating to soil type, soil pH, irrigation related information, tiled area information, previous crop information, fertilizer including nitrogen, phosphorous, and potassium levels, insecticide, herbicide, and biotic data, drainage topography (soil moisture and stresses), crop variety (disease resistance, root systems, ability to adapt to extreme conditions), planting information, harvest information, insect or weed information, crop rotation information, tillage practices (type, timing, wet/dry soil), compaction, soil pH, herbicides (misapplication, drift, phytotoxic effects), subsoil condition (acid or alkaline subsoil, clay layer, fragipan, etc), fertility placement (ridge-till, no-till, etc), fertility level, plant population, etc. This information may be obtained directly from the producer 12 or indirectly, in whole or in part.

Data about related to crops can be collected in various ways, and can include grain analytics, weather data collection, planting data, yield data, soil management data, pest status management data, as well as other types of data. The present invention contemplates that numerous types of technologies can be used to collect the data. For example, grain analytic tools such as, not limited to near infrared (NIR) analyis can be used to assist in determining crop quality. In addition to this type of data collection, the present invention also allows for more conventionally collected information to be used, including information from crop scouts or crop scouting reports.

Another type of information input to the information system is from the input suppliers 10. A seed company is one example of an input supplier 10. A seed company provides information about genetics, genetics-by-environment interactions, or genetics-by-environment-by-management information. The seed company can provide projected harvest date, historical performance data for different varieties of seed, including historical information or predicted information for value differentiating characteristics of seed such as ethanol yield, digestible energy level content, protein content, starch content, extractable starch content. The seed company can also provide recommendations which are used by the producer 12 in determining what type of seed to use in particular environments for a particular end use. In addition, the seed company can provide recommendations to the processor/livestock producer of which type of variety to purchase for a particular end use in order to maximize value.

An input supplier 10, such as a seed company can also use information from the information system 20 in various ways. For example, the input supplier can use information 28 from the information system 20 in their plant breeding program in order to improve their seed. The goal of plant breeding is to combine, in a single variety or hybrid, various desirable traits. Information obtained from the information system 20 can be used to select hybrids with a desired phenotype or performance. The information can be used to facilitate the identification of trait, genetic marker or gene associated or responsible for an important trait relating to the value differentiator. The trait, genetic marker or gene of importance of a crop of interest can then be introduced into a genotype or variety using a host of techniques. New combinations or lines are tested in different environments and their performance evaluated with successful combinations being subsequently commercialized. Thus, breeding programs may be used to develop specific varieties or hybrids that have, or are more likely to have improved performance with respect to one or more value differentiators. Examples of desirable traits for field crops may include reducing the time to crop maturity, increased ethanol yield, increased predicted digestible energy levels, increased protein content, increased starch content, increased oil content.

The processor/livestock producer 18 receives direct benefits from the information system 20 as the information system 20 allows the processor/livestock producer 18 to manage variability. The variability managed includes variability in the quantity as well as quality of grain as well as variability in timing of when the grain is received and other logistics. By being able to predict the quality of grain and the timing of harvest and delivery of grain in advance, the processor benefits significantly in managing their own operations.

The information system 20 provides for maintaining one or more crop index systems. The crop index is used to provide information on a crop to downstream players to enable them to more effectively manage their supply chains. The crop index system provides real time and predictive crop conditions, harvest dates, moistures, volumes, and grain characteristics in order to enhance supply chain efficiency. The crop index system can use data obtained from grain analytics, weather data collection and analysis, planting data, yield data, soil management data, and pest status management data. Thus, by examining the crop index, a processor or livestock producer will be able to obtain information on grain quality, crop production status, and grain volume prior to harvest, and prior to processing or feeding so that the processor or livestock producer can better manage their resources. For example in ethanol processing, where grain to be harvested is known to have a particularly high ethanol content, an ethanol processor will know that less grain will be required. Where the ethanol processor knows that there will be a late harvest in one region, the ethanol processor will know to alter their production schedule to wait for the late harvest grain or obtain grain from a different region with an earlier harvest if grain is needed prior to the late harvest. The processor may also take into account expected delivery times instead of or in addition to harvest times. Grain harvested in different areas may take longer to be delivered. Grain having higher moisture content may be dried for longer periods of time thereby increasing the time to delivery.

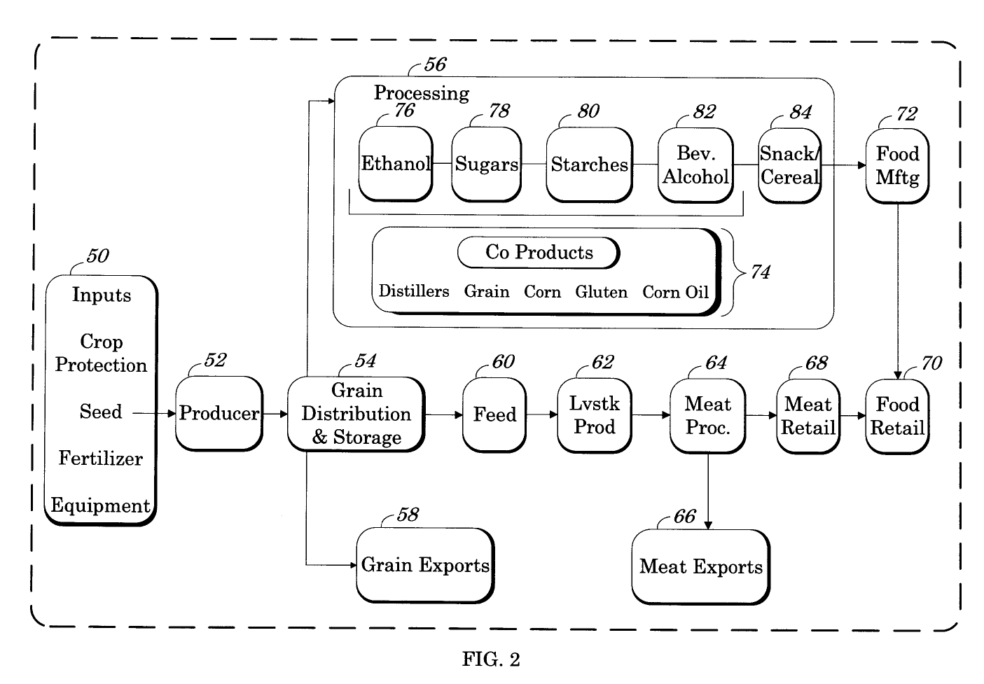

FIG. 2 illustrates supply chains for corn. As shown in FIG. 2 agricultural inputs 50 such as seed, fertilizer, irrigation, equipment and crop protection are provided to a producer 52. The producer 52 produces corn which is provided to a grain distribution and storage participant 54 in the supply chain. The grain distribution and storage participant 54 stores and/or distributes, provides the corn for further processing 56, feed 60, or export 58. Where the corn is provided for processing operations 56, the processing operation 56 may be ethanol processing 76, sugars processing 78, starches processing 80, beverage alcohol processing 82, snack/cereal processing 84. In different types of processing, different characteristics for the grain may be at a premium. The processing may result in produces used in food manufacturing 72 which is then provided to a food retailer 70. In another example, the grain is used for feed 60 which is used in livestock production 62. Meat processing 64 uses the livestock and can have the meat exported in step 66 or sent to a meat retailer 68 and potentially onto a food retailer 70.

In one exemplary embodiment, a supply chain for ethanol is optimized. The ethanol market is currently experiencing high growth. Ethanol is generally blended with gasoline at various levels to fuel motor vehicles. Due to limited supplies of crude oil and limitations in refining capacity, concerns over environmental degradation, and the resulting increase in gasoline prices, there appears to be a good outlook for further growth in the ethanol market. Ethanol can be produced from various sources, including corn, barley, and wheat, as well as cellulose feedstocks. For purposes of this exemplary embodiment, corn is used to produce ethanol.

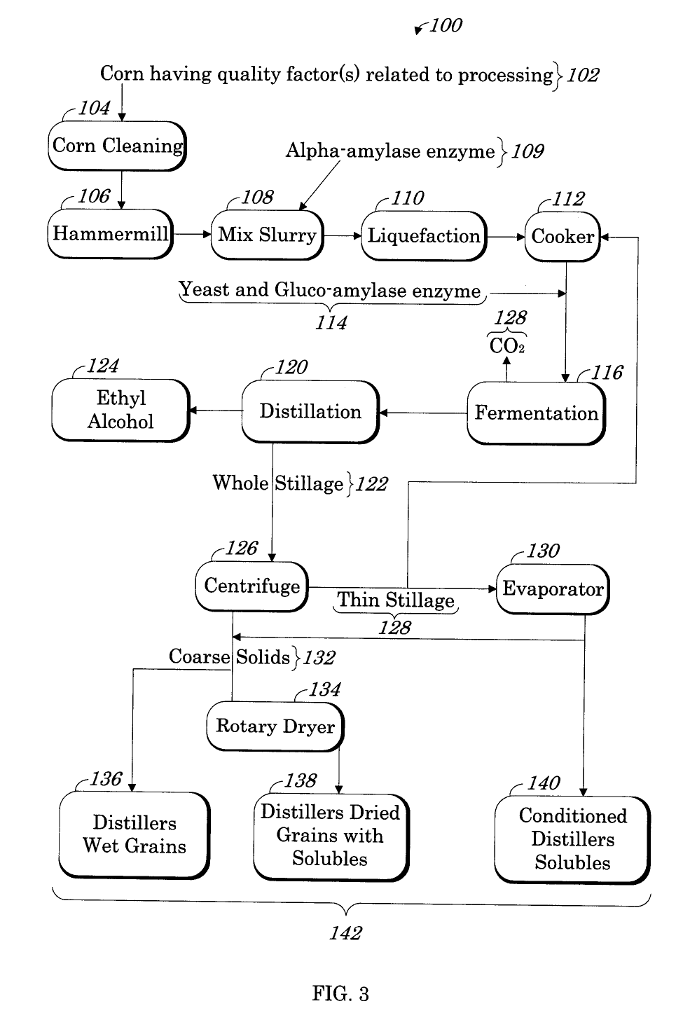

FIG. 3 illustrates one embodiment of a corn dry-milling process which can be used as a part of the present invention. As shown in FIG. 3, corn 102 is provided and undergoes a corn cleaning process 104, followed by a hammermill process 106. In step 108 a slurry mixing step is performed and an enzyme, such as an alpha-amylase enzyme 109, is introduced. In step 110, liquefaction occurs in step 116 where carbon dioxide 118 is produced. In step 120, distillation occurs which produces ethyl alcohol 124. Whole stillage 122 is also produced. A centrifuge 126 is used to produce thin stillage 128, which may undergo additional cooking, returning to the cooker 112, or else the thin stillage is provided to an evaporator 130. The resulting coarse solids 132 are returned to a rotary dryer 134 and/or as a distillers wet grain 136 co-product. The solubles are provided as conditioned distillers soluble co-product 140. The rotary dryer 134 is also used to produce distillers dried grain with solubles 138. The process shown in FIG. 3 is merely one embodiment of a corn dry milling process. Each processor may have different or varying steps. The present invention contemplates that depending upon the specific process steps used by a processor, different types of corn may be of different value. Generally, for ethanol production, for example, a waxy corn is preferred. The present invention contemplates that numerous characteristics of corn, including those defined by genetics, environment, and genetic-by-environment interaction relate to the quality of corn for the particular process. The present invention also recognizes that variations in processing steps may result in grain of different genetics having higher quality. For example, in the corn dry milling process of FIG. 3, an alpha-amylase enzyme 109 and a gluco-amylase enzyme 114 are used. The present invention recognizes that such enzymes have differing results when used in the same process but with corn of differing genetics. Therefore, the quality of grain may vary according to the specific processing steps of a processor. In addition, a processor may vary their processing steps according to the specifics of grain being processed. The general effect of genetics on processing is well known. For example, as shown in FIG. 3, ethyl alcohol 124 is produced and it is known that greater amounts of ethyl alcohol are produced where certain traits, such as a waxy trait are present in the genetics of the corn or maize. Thus, the present invention contemplates that depending upon what is being produced, and the processing steps used, crops of different genetics will have different qualities.

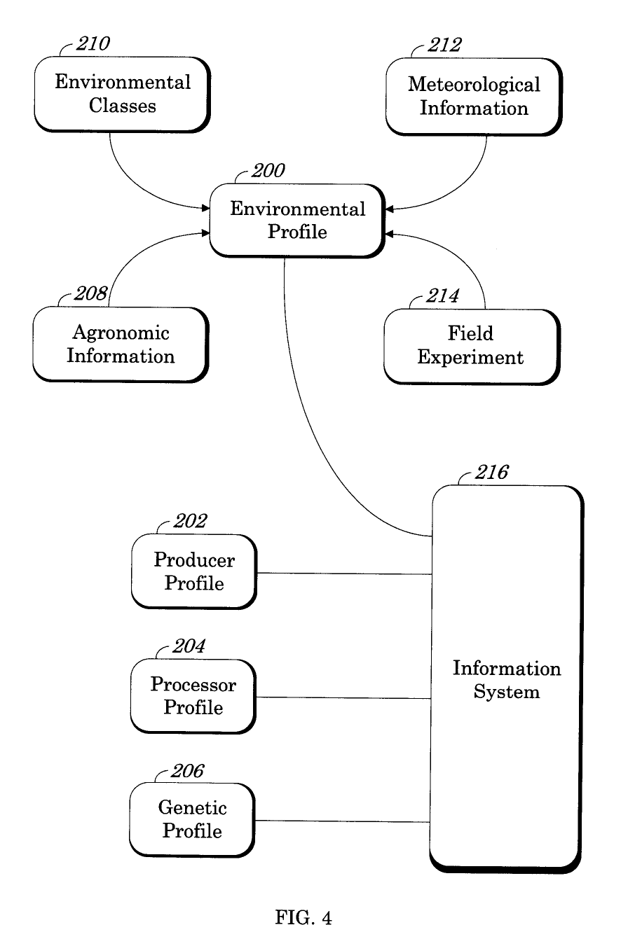

FIG. 4 illustrates another embodiment of the present invention. In FIG. 4, an environmental profile 200, a producer profile 202, a processor profile 204, and a genetics profile 206 are each operatively connected to an information system 216. The environmental profile 200 may incorporate the use of one or more of environmental classes 210, meteorological information 212, agronomic information 207, and field experiment information 214.

The environmental classes 210 are a mechanism used to describe variations in environment, environment-by-genetic interactions, and environment-by-genetics-by management interactions. There are numerous potential variations in the environment and production practices which can affect the performance of a crop or the relative performance of crops having different genotypes. Environmental classification is one way in which to describe and therefore, assist in managing those variables. Environmental classification may be used to assist in selecting a genotype, describing its performance, or predicting its performance or relative performance. Environmental classifications may be determined based on climate, disease incidence, insect population, farm management practices, or other variables. The present invention is not limited to a particular environmental classification.

The environmental classification system described in U.S. Provisional Patent Application No. 60/689,716 filed Jun. 10, 2005, is incorporated by reference in its entirety herein. Where environmental classification is used, the present invention contemplates that these environmental classifications can be derived from data from many different locations over time. The present invention contemplates that, depending upon the particular environmental classification system used, a land base may not have the same environmental classification year-to-year. Thus, environmental classifications can be based on data collected over a number of years and a number of locations.

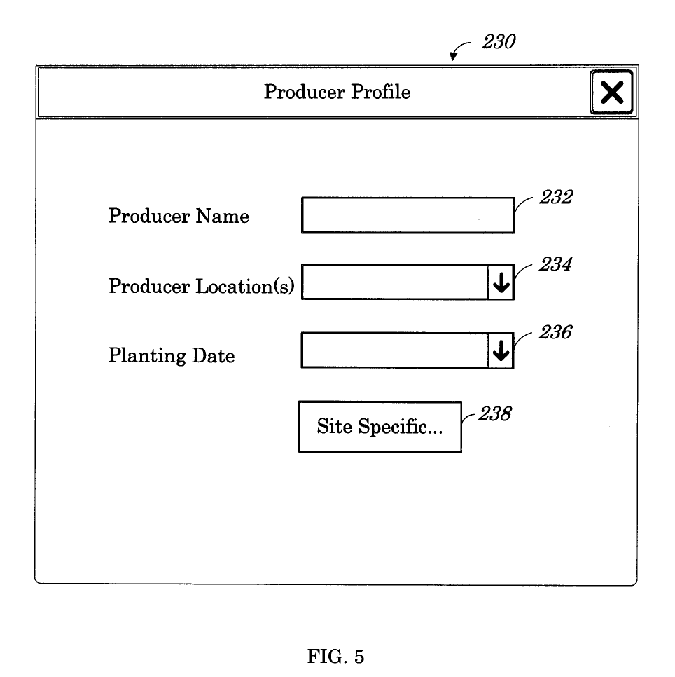

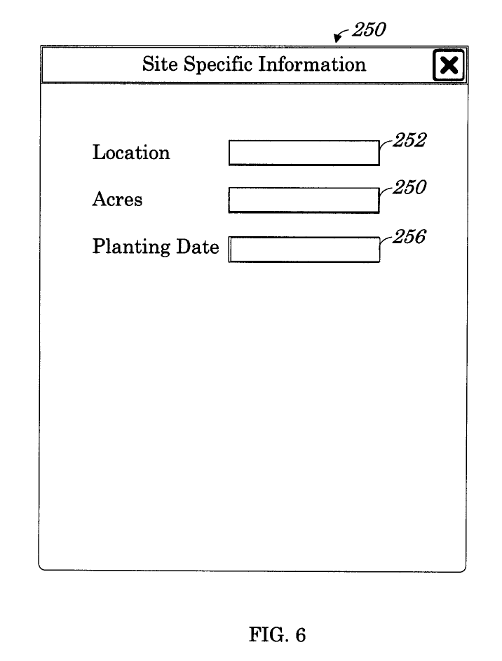

FIG. 5 illustrates one embodiment of a screen display associated with a producer profile. Information associated with a producer can include a producer name 232, a producer location or locations 234, the number of acres 336, as well as site specific information 238. The present invention contemplates that a single producer may grow crops in more than one area. Some production operations may be spread across states, encounter different environments, different types of soil, or otherwise provide variability in terms of environmental profile. Therefore, in such instances, it is advantageous to divide the land base associated with a particular producer into site specific information. The present invention also contemplates that a single producer may grow different hybrids or varieties in different location. FIG. 6 provides one embodiment of a screen display related to the collection or display of site specific information associated with an environmental profile. Site specific information includes location 242 which may be provided via geo-coordinates such as latitude or longitude, or otherwise. Site specific information may also include number of acres 254. Site specific information may also include information specific to each field such as planting date 256. That which is shown is merely representative.

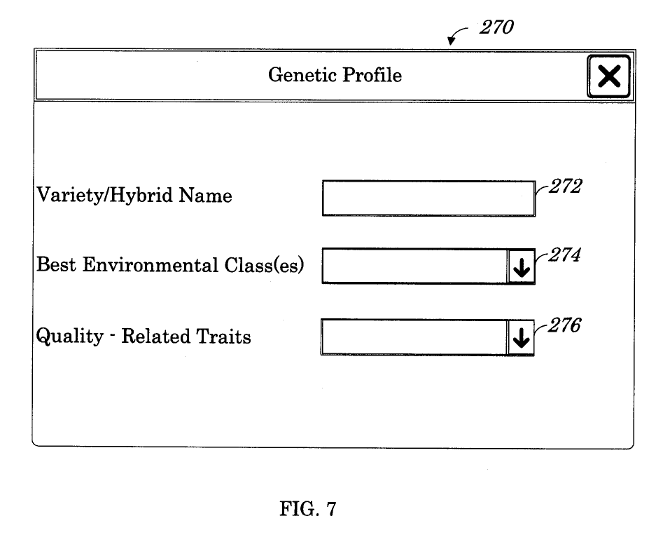

FIG. 7 illustrates one embodiment of a screen display 270 associated with a genetic profile. The genetic profile screen display 270 includes a variety/hybrid name field 272, one or more preferred environmental classes 274 associated with the variety/or hybrid name, and quality-related traits 276.

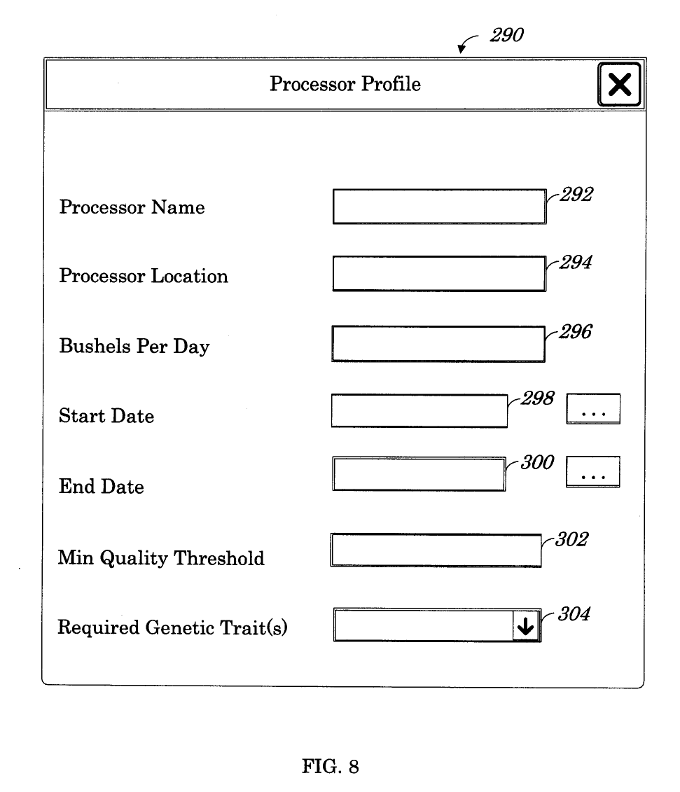

FIG. 8 illustrates one embodiment of a screen display 290 associated with a processor profile. The processor profile information may include information such as a processor name 292, a processor location 294. The processor profile may also desired inputs such as a number of bushels per day 296 during a particular time period such as a start date 298 and an end date 300. The processor profile may also include quality-related characteristics and thresholds 302. The processor profile may also include required genetic traits 304. That which is shown is merely exemplary. The processor profile provides information about a processor and their input requirements. This information can take numerous different specific forms. Generally, it will include input requirements for a particular time duration, quality requirements or thresholds, and genetic traits. The present invention recognizes that the genetic traits desired by a processor may relate to processing. For example, a particular genotype may have decreased processing time when used in conjunction with a particular enzyme such as an alpha-amylase enzyme or a gluco-amylase enzyme. The present invention provides a convenient method for collecting and analyzing information from different sources in order to assist in optimizing a supply chain.

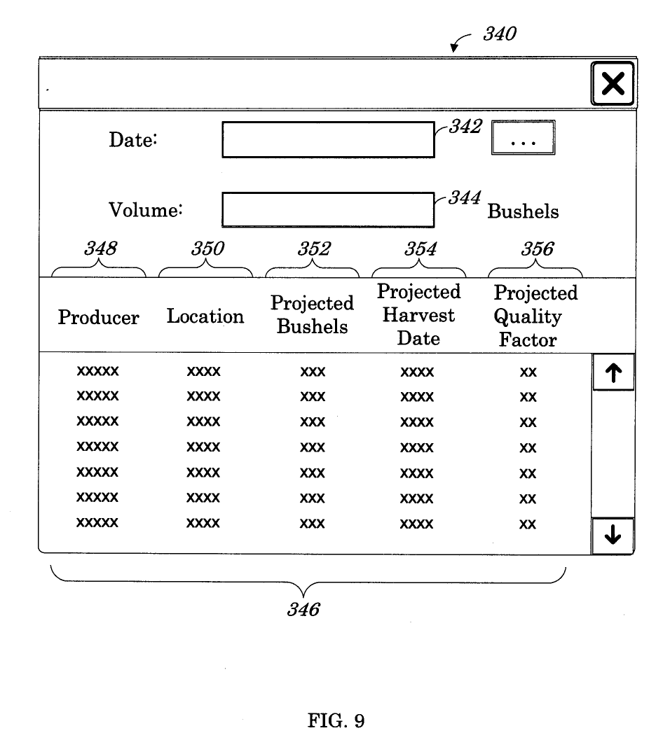

FIG. 9 illustrates one embodiment of a screen display 340 illustrating information regarding sources of grain to potentially procure in order to meet production demand. For a time period such as a date 342, a volume 344 of grain required is provided. The present invention contemplates that instead of indicating a volume 344 of grain, although production needs may be expressed. It is to be understood that varying amounts of grain would be needed to produce the same amount of a product due to variances in the quality of the grain. Producer information 346 is provided, including producer name 348, location 350, projected bushes 352, projected harvest date 354, and projected quality factor 356. The projected quality factor 356 can relate to a single characteristic of grain, or can be weighted according to a number of different characteristics. Instead of only one quality factor, the present invention contemplates that any number of quality factors can be provided. Based on information such as that provided in screen display 340, a processor can determine how best to source their grain needs. Of course, the present invention contemplates numerous variations in the specific type of reporting performed. For example, instead of providing a projected harvest date, a projected delivery date can be provided. Instead of reporting concerning a particular date, a processor may want information to be organized by one or more quality factors and may want to acquire all of the grain having the highest projected quality factor regardless of its projected date of harvest or delivery.

What has been described herein is merely exemplary. The present invention contemplates numerous variations in the type of crop, the end use for the crop, the amount and type of data collected, the manner in which the data is analyzed and reported, and other variations. The present invention is not to be limited to this specific disclosure.

What is claimed is:

1. A method for optimizing a supply chain for grain, comprising:
providing an information system adapted to exchange information with at least one input supplier providing seed to the producer, at least one producer providing grain grown from the seed, and at least one processor providing a product produced using the grain;
wherein the information system is adapted to provide an output indicative of grain quality to the at least one processor prior to harvest of the grain to thereby assist the at least one processor in optimizing the supply chain.

2. The method of claim 1 wherein the at least one processor includes an ethanol processor.

3. The method of claim 2 wherein the output indicative of grain quality is an ethanol yield potential output.

4. The method of claim 3 wherein the grain is corn.

5. The method of claim 1 wherein the at least one processor includes a livestock producer.

6. The method of claim 5 wherein the output indicative of grain quality is predicted digestible energy levels.

7. The method of claim 6 wherein the grain is corn.

8. The method of claim 1 wherein the output indicative of grain quality is protein content.

9. The method of claim 1 wherein the output indicative of grain quality is oil content.

10. The method of claim 1 wherein the output indicative of grain quality is starch content.

11. The method of claim 1 wherein the output indicative of grain quality is extractable starch content.

12. The method of claim 1 wherein the output indicative of grain quality is enzyme content.

13. The method of claim 1 wherein the output indicative of grain quality is lysine content.

14. The method of claim 1 wherein the grain quality is determined using near infrared analysis.

15. The method of claim 1 wherein the grain quality is predicted based on genetics of the seed used to grow the grain, management practices of the producer, and an environment in which the seed is grown.

16. The method of claim 1 wherein the exchange of information between the at least one input supplier providing seed to the producer and the information system is a two-way exchange.

17. The method of claim 16 further comprising incorporating information received from the exchange of information between the at least one input supplier providing seed to the producer and the information system into a breeding program.

18. The method of claim 1 wherein the grain quality is predicted based on genetics of the seed used to grow the grain and the effect of the genetics on grain processing.

19. The method of claim 18 wherein the grain processing comprises applying an enzymatic process and wherein the genetics of the seed affects the enzymatic process.

20. The method of claim 18 wherein the grain processing is processing for ethanol production.

21. The method of claim 18 wherein the grain processing comprises wet milling.

22. The method of claim 18 wherein the grain processing comprises dry grinding.

23. A method for optimizing a supply chain for grain, comprising:
providing an information system adapted to exchange information with at least one input supplier providing seed to the producer, at least one producer providing grain grown from the seed, and at least one processor providing a product produced using the grain;
wherein the information system is adapted to provide an output indicative of grain quality to the at least one processor prior to harvest of the grain to thereby assist the at least one processor in optimizing the supply chain.

24. The method of claim 23 wherein the at least one input supplier includes a seed supplier.

25. The method of claim 23 wherein the output indicative of grain quality being at least partially based on crop scouting reports.

26. The method of claim 23 wherein the output indicative of grain quality being at least partially based on interaction between the genetics of the grain and processing techniques.

27. The method of claim 26 wherein the processing techniques include use of one or more enzymes.

28. A method for acquiring grain, comprising:
determining expected grain quality from a plurality of sources at a time prior to harvest of the grain, the expected grain quality based on genetics of the grain, the environment associated with the grain, and genetics-by-environment interactions;
determining an expected time of harvest for the grain;
identifying sources of grain to acquire to meet processing needs based on expected grain quality, expected time of harvest, and processing needs.

29. The method of claim 28 wherein the step of identifying sources of grain to acquire to meet processing needs being further based on interactions between processing steps and grain of varying genetics.

30. The method of claim 29 wherein the processing steps include use of enzymes.

31. A method for optimizing a supply chain for grain, comprising:
determining expected grain quality from a plurality of sources at a time prior to harvest of the grain, the expected grain quality at least partially based on genetics of the grain, the environment associated with the grain, genetics-by-environment interactions, and effect of the genetics of the grain on processing steps;
identifying sources of grain to acquire to meet processing needs at least partially based on the expected grain quality.

32. The method of claim 31 further comprising determining an expected time of harvest of the grain prior to harvest.

33. The method of claim 32 wherein the step of identifying sources of grain is at least partially based on the expected time of harvest of the grain.

34. The method of claim 31 further comprising determining an expected time of delivery of the grain prior to harvest.

35. The method of claim 34 wherein the step of identifying sources of grain is at least partially based on the expected time of delivery of the grain.

36. The method of claim 34 wherein the processing steps include at least one step using an enzyme.

37. The method of claim 34 wherein the expected grain quality at least partially based on genetics-by-environment-by-management interactions.
